(19) United States
(12) Patent Application Publication
(10) Pub. No.: US 2026/0250003 A1
(43) Pub. Date: Aug. 27, 2026

(54) CONTROL SYSTEM FOR AN AIRCRAFT PROPULSION UNIT

(71) Applicant: SAFRAN NACELLES, Gonfreville-L'Orcher (FR)

(72) Inventors: Clément BOUQUET, Moissy-Cramayel (FR); Pierre Charles CARUEL, Moissy-Cramayel (FR)

(73) Assignee: SAFRAN NACELLES, Gonfreville-L'Orcher (FR)

(21) Appl. No.: 19/045,623

(22) Filed: Feb. 5, 2025

(30) Foreign Application Priority Data
Feb. 6, 2024 (FR) FR2401171

(51) Int. Cl. B64D 31/04; B64C 25/34; B64C 25/42; B64D 27/10; F02K 1/76

(52) U.S. Cl. CPC B64D 31/04; B64C 25/34; B64C 25/42; B64D 27/10; F02K 1/763

(57) ABSTRACT

The invention relates to a system (120) for controlling an aircraft propulsion unit (1), the propulsion unit comprising a turbine engine (2) configured to generate a direct thrust flow (50a), as well as a thrust reverser (30), the control system comprising at least one control member (122, 124) operable by an operator. According to the invention, the control system is configured so that, when the taxiing speed of the aircraft is less than or equal to a reference speed, the control member (122, 124) can be moved into a position in which the control system instructs the thrust reverser (30) to occupy a partial opening configuration between the closed configuration and the open configuration, so as to generate an intense reverse-thrust flow (50b).

### TECHNICAL FIELD

The invention relates to the field of control systems of an aircraft propulsion unit, and more particularly to controlling the traveling of the aircraft at low speed.

### PRIOR ART

During the traveling phases of an aircraft, also referred to as “taxi phases”, this aircraft is propelled by the direct thrust generated by its propulsion units. When the aircraft needs to be slowed down, for example to make turns or to reduce its speed at runway intersections, brakes that act on the wheels of the aircraft are traditionally used.

However, intensive use of the brakes is not desirable, as it reduces their service life, especially in cold conditions in the case of carbon brakes. However, the turbine engines used on aircraft, particularly commercial aircraft, have high dilution rates that induce high direct thrust at engine idle speed. This leads to increased use of the wheel brakes of the aircraft, with the detrimental consequences described above.

In addition, the use of the brakes during the taxiing phases can be a source of discomfort for the passengers, since the braking forces are applied to the wheels of the main landing gear, close to the ground. They thus generate a torque on the aircraft that tends to make the front wheel of the landing gear dip. This phenomenon is undesirable because it is noticeable in the cabin, with the sensation of forward rotation for the passengers.

To overcome these problems, it has been considered using thrust reversers as a braking source during taxiing phases, and as a means of limiting thrust when the engine is idling and the aircraft is stationary on the ground. However, this solution has so far been reserved for small aircraft, i.e. mainly business aircraft. In the case of aircraft with high dilution rates encountered on turbine engines of commercial aircraft, thrust reversers are usually not used below a reference taxiing speed, also called reverser cut-off speed and generally set between 50 and 70 knots. This because, even in the position of the throttle lever that controls a reverse-thrust flow of minimum intensity, the reverser is placed in its open configuration, i.e. its configuration having the maximum opening. Below the cut-off speed, the braking force generated by the reverse-thrust flow may prove to be too high compared with the requirements encountered, even when this reverse-thrust flow is of minimal intensity. In addition, still below the cut-off speed, full opening of the reverser creates a risk of reinjection of the reverse-thrust flow, as well as a risk of injection of foreign bodies lifted from the ground by this flow, such as gravel.

So far, few solutions have been provided to respond to this problem of braking the aircraft when it is taxiing below the cut-off speed, or reducing the thrust at idle, at standstill. For example, a solution was provided by document FR 3,093,996 A1, disclosing a thrust reverser capable of generating a slowdown of the aircraft by reducing the direct thrust. To this end, a double-grille system is implemented, with a second set of grilles having members directing the flow downstream, namely opposite to the members redirecting the flow upstream equipping a first set of grilles. The first and second sets of grilles are deployed alternately, depending on the desired force. However, this solution can still be improved, both in terms of performance and simplicity of design.

### DESCRIPTION OF THE INVENTION

In order to respond to the disadvantages relating to embodiments of the prior art, the invention firstly relates to a control system of an aircraft propulsion unit, according to the features of claim 1, and of the dependent claims.

The invention thus provides for a simple and efficient solution, making it possible to brake the aircraft in taxiing phase below the reference speed, the order of magnitude of which is preferably that usually adopted for the shutdown speed of the reversers. This is because, instead of prohibiting the use of the reverser in the taxiing phase below the reference speed, the invention advantageously provides for controlling the reverser so that it opens only partially, and so that it generates a reverse-thrust flow of fairly low intensity, meeting the braking needs, and possibly also the need to reduce the thrust produced at ground idle (tickover), when the speed of the aircraft must be maintained at zero. Indeed, the principle of the invention could also be applied when the aircraft is stationary on the ground, to keep it stationary, in order to counteract the thrust generated during an engine idle speed. This thrust may be significant, particularly on commercial aircraft due to the increase in the dilution rate of the turbine engines fitted to these aircraft.

This design specific to the present invention is also advantageous in that it makes it possible to limit wear of the wheel brakes. The wear on the reverser caused by its deployment in the low-speed taxiing phase also remains contained, as this deployment may only be partial. This leads to lower forces on parts usually sized for thrust reversal mode, such as grilles, door pivots, and actuators. The service life of these elements is advantageously improved.

Finally, the use of the reverser in the taxiing phase, below the reference speed and replacing or supplementing the wheel brakes, also makes it possible to improve passenger comfort during braking.

The invention preferably provides for at least one of the following optional technical features, taken alone or in combination.

Preferably, the control member is a throttle lever capable of being placed in an engine idle position, and moved in a first direction from this engine idle position, toward a full throttle position, and moved in a second direction still from this engine idle position, in a thrust reversal control zone, toward a maximum thrust-reversal position. Furthermore, the control system is configured so that, when the taxiing speed of the aircraft is less than or equal to the reference speed, the throttle lever can be moved within the thrust reversal control zone into at least one intermediate thrust-reversal position in which the control system instructs the thrust reverser to occupy said partial opening configuration.

Alternatively, the control member could be a brake pedal. Its actuation, for example from a certain travel and/or according to a speed of movement of this pedal by the action of the foot of the operator, could cause the control system to demand the same action as that described below in the context of the use of the throttle lever, as well as all or some of the actions that will be described below.

Preferably, the control system is configured so that, when the taxiing speed of the aircraft is less than or equal to said reference speed and the throttle lever is placed in the engine idle position, the control system instructs the thrust reverser to occupy a minimum partial opening configuration, so as to generate the reverse-thrust flow with a minimum intensity, preferably corresponding to the intensity of the direct thrust flow escaping the turbine engine, so that the propulsion unit generates zero or substantially zero thrust. Thus the invention advantageously provides that, in the taxiing situation at low speed, the engine idling position generates a resultant of zero or substantially zero forces for the propulsion unit. This improves the ease of control of the aircraft in this particular situation, and reduces brake wear.

Alternatively, the control system could be configured so that, in the engine idle position, the minimum intensity of the reverse-thrust flow generated by the reverser remains lower or higher than the intensity of the direct thrust flow escaping the turbine engine, so that the propulsion unit generates a low thrust or a low reverse thrust.

Preferably, the control system is configured such that, when the taxiing speed of the aircraft is less than or equal to said reference speed and the throttle lever occupies any first intermediate position within a first portion of the reversing control zone located between the engine idle position, and a reference intermediate position, the control system instructs the thrust reverser to occupy a partial opening configuration, whose opening level is a function of the first intermediate position within the first portion of the reversing control zone, so as to generate the reverse thrust flow with an intensity greater than that of the direct thrust flow escaping the turbine engine, so that the propulsion unit generates a reverse thrust, preferably while maintaining the idle speed.

Alternatively, in this first portion of the switching control zone between the engine idle position and the reference intermediate position, in addition to continuing to open the reverser, the control system could simultaneously demand an increase in engine speed, rather than keeping it constant at idle speed.

Preferably, in the intermediate reference position of the throttle lever, the control system instructs the thrust reverser to occupy a maximum taxiing opening configuration, corresponding to a maximum partial opening configuration of the reverser, or to its open configuration.

Preferably, the control system is configured so that, when the taxiing speed of the aircraft is less than or equal to said reference speed and the throttle lever occupies any second intermediate position within a second part of the reversing control zone located between the reference Intermediate position, and the maximum reverse thrust position, the control system instructs the thrust reverser to maintain its maximum taxiing opening configuration, and instructs the application of an engine speed that is a function of the second intermediate position within the second part of the reverse control zone, so as to generate the reverse thrust flow with an intensity greater than that of the direct thrust flow escaping the turbine engine, so that the propulsion unit generates a reverse thrust.

Preferably, said throttle lever is also used for controlling the engine speed in flight, as well as for controlling the thrust reverser at landing, in particular when the speed is greater than the reference speed. Thus, for the same position of the throttle lever in the reversal-control zone, the command of the reverser and/or of the engine speed may differ depending on the phase in which the aircraft is located, and in particular differ between the landing phase and the taxiing phase below the reference speed.

According to an alternative, said throttle lever is provided in addition to a main throttle lever used for controlling the engine speed in flight, as well as for controlling the thrust reverser at landing, the control system being then configured so that the throttle lever has authority over the main throttle lever as soon as the taxiing speed of the aircraft is less than or equal to the reference speed.

Preferably, said throttle lever is provided in addition to a main throttle lever used for controlling the engine speed in flight, as well as for controlling the thrust reverser at landing, the control system being then configured so that the throttle lever has authority over the main throttle lever as soon as the taxiing speed of the aircraft is less than or equal to the reference speed.

Preferably, the system comprises at least one brake pedal, the system being configured such that the actuation of said at least one brake pedal is considered as an additional braking request by the operator, and so that, following the detection of such braking, the system implements, in addition to wheel braking, an action consisting in ordering the thrust reverser to increase its opening if this is still possible, and/or increase the engine speed if this is still possible.

Preferably, the reverser comprises at least one actuator driven by an electric motor equipped with a braking mechanism configured to hold the reverser in its partially open configuration.

Preferably, the control system furthermore comprises:
an engine regulation system connected to the control member so that the position thereof is transmitted to the regulation system, the latter being configured to deliver opening/closing instructions to the thrust reverser, as well as to deliver engine speed instructions to the turbine engine;
a processing unit connected to the engine control system, the processing unit being configured to receive information relating to the taxiing speed of the aircraft, and to transmit this information to the engine control system, for example the FADEC, an acronym for “Full Authority Digital Engine Control”, and corresponding to a digital control system centered on a computer with two symmetrical, redundant, and full-authority channels.

The invention also relates to a method for controlling an aircraft propulsion unit using such a control system. When the taxiing speed of the aircraft is less than or equal to a reference speed, the thrust reverser is ordered, in response to the placing of the control member in a given position, to occupy a partial opening configuration between the closed configuration and the open configuration, so as to generate a reverse thrust flow of lower intensity than that generated in the open configuration.

Of course, this process is intended to implement all or part of the actions described above in relation to the control system.

Finally, the invention also relates to an aircraft comprising at least one propulsion unit as well as such a control system of this unit, the propulsion unit comprising a turbine engine configured to generate a direct thrust flow, as well as a thrust reverser configured to adopt:
a closed configuration in which the thrust reverser is inactive; and
an open configuration in which the thrust reverser is active, the open configuration allowing the reverser to deflect at least a part of a flow passing through the turbine engine, in order to form a reverse thrust flow escaping the propulsion unit with an axial direction opposite to that of the direct thrust flow.

Preferably, the thrust reverser of the propulsion unit includes flow redirection members for generating the reverse thrust flow, the control member being a throttle lever, and the reverser is designed so that these same flow redirection members are used both when the lever is placed in a position in which the control system Instructs the thrust reverser to occupy a partially open configuration between the closed configuration and the open configuration, and when this lever is placed in a maximum reverse thrust position. More generally, these same flow redirection members are preferably used in whole or in part when the reverser is active, regardless of the position of the throttle lever, the phase in which the aircraft is located, and its speed.

Other advantages and features of the invention will appear in the non-limiting detailed description below.

### BRIEF DESCRIPTION OF THE DRAWINGS

The following detailed description refers to the attached drawings on which:

FIG. 1 is a side view of an aircraft;

FIG. 2 is a schematic view of a turbine engine equipping the aircraft shown in the previous figure, with its control system which is in the form of a preferred embodiment of the invention, the top half-view showing the thrust reverser in open configuration, and the bottom half-view showing the thrust reverser in closed configuration;

FIG. 3 is a perspective view of the turbine engine shown in the previous figure, with its thrust reverser shown in open configuration;

FIG. 4 is a schematic plan view of a throttle lever module, equipping the control system shown in FIG. 2;

FIG. 5 is a diagram showing the control logic of the control system;

FIG. 6 is a double graph showing, in the upper part, the control of the engine speed as a function of the position of the throttle lever, and showing, in the lower part, the control of the opening of the reverser, still as a function of the position of the throttle lever;

FIG. 7 is a schematic longitudinal half-sectional view of a part of the turbine engine, and of its reverser shown in the configuration as adopted when the taxiing speed of the aircraft is less than or equal to a reference speed, and with the throttle lever in the engine idle position;

FIG. 8 is a schematic longitudinal half-sectional view similar to the previous one, with the reverser shown in the configuration as adopted when the taxiing speed of the aircraft is less than or equal to a reference speed, and the throttle lever occupies an intermediate reference position;

FIG. 9 is a schematic perspective view of a part of the control system, according to an alternative;

FIG. 10 is a schematic longitudinal sectional view of a turbine engine similar to that of FIG. 2, and equipped with a thrust reverser in the form of an alternative;

FIG. 11 is a schematic view of an electric actuator of the reverser, and its control means.

### DETAILED DESCRIPTION OF EMBODIMENTS

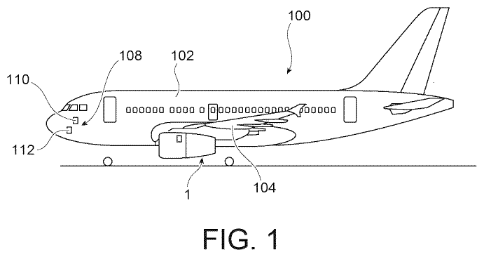

With reference to FIG. 1, an aircraft 100, of the commercial aircraft type, is shown. This aircraft comprises a fuselage 102, as well as wings 104 (only one being visible in the side view of FIG. 1). One or more propulsion units 1 are mounted on each wing 104, preferably suspended.

Each propulsion unit 1 comprises in particular a turbine engine, and a thrust reverser, as will be detailed later.

At the front, the aircraft has a cockpit 108, in which one or more elements of a control system of the propulsion unit 1 are located, such as a throttle lever module 110, or a brake pedal module 112.

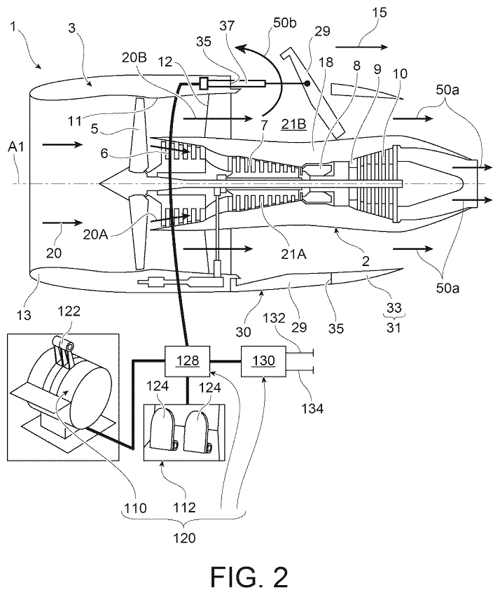

FIG. 2 shows one of the propulsion units 1, accompanied by its control system 120 specific to the invention. All the propulsion units 1 of the aircraft are of identical or similar design, and controlled in the same or similar manner. Thus only one of the units 1 will be described below, with its control system 120.

The propulsion unit 1 has a longitudinal central axis A1. Subsequently, the terms “upstream” and “downstream” are defined relative to a general direction 15 of flow of gases through the propulsion unit 1, along the axis A1 when it generates a direct thrust. These terms “upstream” and “downstream” may be replaced by the terms “front” and “rear”, respectively, with the same meaning.

The propulsion unit 1 comprises a turbine engine 2, a nacelle 3, and a mast (not shown), intended to connect the propulsion unit 1 to a wing of the aircraft.

The turbine engine 2 is in this example a bypass twin-spool turbojet comprising, from the front to the rear, a fan 5, a low-pressure compressor 6, a high-pressure compressor 7, a combustion chamber 8, a high-pressure turbine 9 and a low-pressure turbine 10. The compressors 6 and 7, the combustion chamber 8, and the turbines 9 and 10 form a gas generator. The turbojet 2 has a blower housing 11 connected to the gas generator by structural arms 12.

In operation, an air flow 20 enters the propulsion unit 1 through the air inlet 13, passes through the blower 5 then divides into a primary flow 20A and a secondary flow 20B. The primary flow 20A flows into a primary gas-circulation duct 21A passing through the gas generator. The secondary flow 20B flows into a secondary duct 21B surrounding the gas generator. The secondary duct 21B is delimited radially inwards by a fixed inner fairing 18 that surrounds the gas generator. This fairing 18 is an integral part of a fixed structure of a thrust reverser which will be described below. This same fairing is also referred to as the radially internal delimiting wall 18 of the secondary duct 21B.

Radially outwards, the secondary duct 21B is delimited by the fan housing 11, and by one or more reverser covers 33 forming a part of the rear section of the nacelle 3.

The nacelle 3 therefore includes a thrust reverser 30 centered on the axis A1 and comprising, on the one hand, a fixed structure 31 integral with the fan housing 11 and including the covers 33, and, on the other hand, a structure movable with respect to the fixed structure 31. In this preferred embodiment of the invention, the reverser is of the door type, i.e. the movable structure is formed by a plurality of movable doors 29, distributed around the axis A1.

On the lower half-section of FIG. 2, the reverser 30 adopts a closed configuration, in which the reverser is inactive. In this closed configuration, each door 29 seals a radial opening 35 through the cover 33, and has a radially internal surface that locally reconstitutes the secondary duct 21B, as well as a radially external surface that locally reconstitutes the outer surface of the nacelle.

In this configuration, the thrust reverser 30 generates reverse thrust flow, while the turbine engine generates a direct thrust flow 50a corresponding to the addition of the primary and secondary flows 20A, 20B.

On the upper half-section of FIG. 2, the reverser 30 adopts an open configuration, in which the thrust reverser is active. In this open configuration, each door 29 is deployed to the maximum, thus releasing its associated opening 35. In this open configuration, the deployed doors 29 make it possible to divert a large part of the secondary flow 20B, in order to form a reverse-thrust flow 50b escaping from the propulsion unit 1 through the openings 35, with an axial direction opposite to that of the direct thrust flow 50a, observed in particular in the closed configuration.

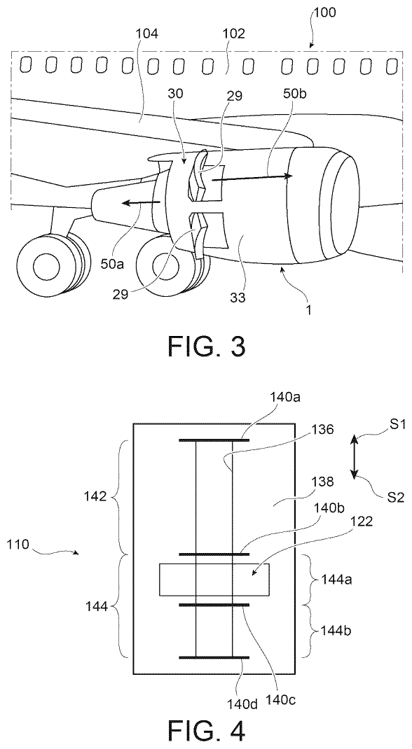

More precisely, in the open configuration, the rear portion of each door 29 is immersed in the secondary duct 21B, preferably up to the inner wall 18, or near it. This rear part thus forms a duct-closing member, in open configuration of the reverser. In addition, the front portion of each deployed door 29 protrudes radially outwards and axially forwards from the reverser cover 33. Due to this particular upward inclination, the front portion of each door 29 forms a flow redirection member, for generating the reverse-thrust flow 50b. Still in this open configuration of the reverser, also shown in FIG. 3, the reverse thrust flow 50b has a higher intensity than that generated by the direct thrust flow 50a which remains. Thus the resultant of these flows 50a, 50b is such that, overall, the propulsion unit 1 generates a maximum reverse thrust braking the aircraft, essentially implemented during its landing.

To switch from one extreme configuration to the other, the reverser 30 is equipped with one or more actuators 37, preferably electric or hydraulic cylinders. These actuators connect the fixed structure 31 of the reverser to each door 29. The axial deployment of the actuator 37 drives the pivoting of its associated door 29 as well as immersion thereof in the secondary duct 21B, thanks to known and conventional kinematics.

Connected to the propulsion unit 1, the aircraft also includes the control system 120 of this unit.

The control system 120 includes the module 110, with its throttle lever 122 forming a control member manually operable by the operator, from the cockpit. It also includes the module 112, with its brake pedal(s) 124 actuated by pressure at their upper end by the feet of the operator, also from the cockpit. The pedals 124 have the function of activating the wheel braking of the aircraft, this braking being carried out herein in a known and conventional manner. Nevertheless, it is recalled that the pedals, or more precisely the joystick, control the steering as a priority, the braking function being Implemented by pressing the upper end of each pedal.

The control system 120 further comprises an engine control system 128, formed by the FADEC which is connected to the control lever 122, so that the position thereof is transmitted to the control system 128. This system 128 is configured to provide opening/closing instructions to the actuators 37 of the thrust reverser 30, as well as to provide engine speed instructions to the turbojet 2.

The control system 120 is supplemented by a processing unit 130 also connected to the engine control system 128. This unit is configured to receive, via dedicated inputs 132, 134, information relating to the position of the aircraft relative to the ground, for example via monitoring the compression of the main landing-gear dampers, as well as its speed, and in particular its taxiing speed when it is on the ground. In addition, the unit 130 is configured to transmit this information to the engine control system 128, which then uses it to control the propulsion unit 1.

With reference now to FIG. 4, the module 110 will be described, and in particular the various positions that the throttle lever 122 can adopt within this module.

The throttle lever 122 is housed in a rail 136 of the module 110, preferably in the form of an arc of a circle. This lever 122 can be articulated at its base on the fixed part 138 of the module. This fixed part 138 also Incorporates, along the rail 136 in which the lever 122 slides when it is rotated by the operator, a visual marking of various key positions of this lever.

Among these key positions, engine idle 140b, full throttle for direct thrust 140a, or maximum reverse thrust 140d are noted. Along the rail 136, a direct thrust control zone 142 is thus provided between the engine idle position 140b, and the full throttle position 140a, offset from the position 140b in a first direction S1 of movement of the lever 122 within its rail 136.

Along the rail 136, a thrust reversal control zone 144 is also provided between the engine idle position 140b, and the maximum reverse thrust position 140d, offset from the position 140b in a second direction S1 of movement of the lever 122 within its rail 136. The first direction S1 is opposite to the second direction S2.

In the thrust reversal control zone 144, a first part 144a as well as a second part 144b are provided, separated from one another by an intermediate reference position 140c, the particularity of which will be described later. Thus the first portion 144a of the reversing control zone 144 is located between the engine idle position 140b and the intermediate reference position 140c, while the second portion 144b of the zone 144 is located between the intermediate reference position 140c, and the maximum reverse thrust position 140d.

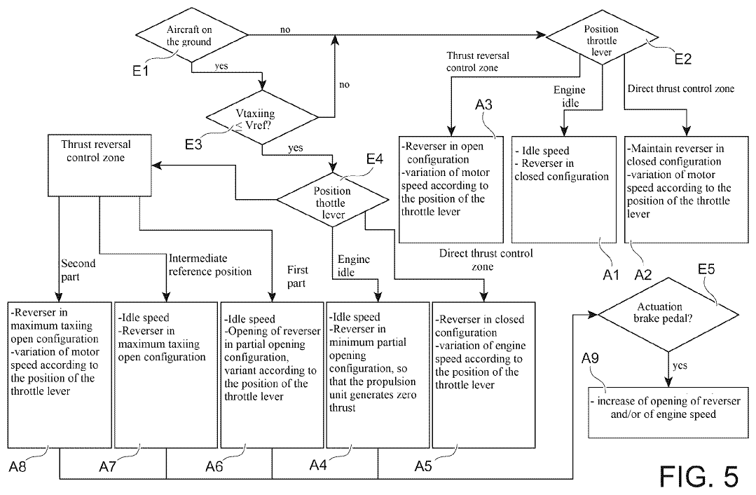

With reference now to FIGS. 5 to 8, the operation of the control system 120 will be described.

It is first detected at an E1 step if the aircraft is on the ground. Otherwise, at a step E2, the position of the lever 122 is determined, which leads to a conventional command. This is because, if the engine idle position 140b is detected, the system 120 implements an action A1 consisting in ordering the thrust reverser to occupy its closed configuration intended to make it inactive, and instructing the turbojet to apply the idle speed. If the detected position is in the direct thrust control zone 142, the system 120 implements an action A2 consisting of instructing the thrust reverser to keep its closed configuration, and instructing the turbojet to apply a speed according to the position of the lever 122. The further this position will be from the engine idle position 140b in the direction S1, the higher the speed, and the greater the direct thrust flow. Finally, if the detected position is in the thrust reversal control zone 144, the system 120 implements an action A3 consisting in instructing the thrust reverser to occupy its open configuration intended to make it active, and instructing the turbojet to apply a speed according to the position of the lever 122. The further away this position will be from the engine idle position 140b in the second direction S2, the higher the rotational speed will be, and the greater the thrust reversal flow.

This control logic is also adopted when the aircraft is on the ground, and is moving at a taxiing speed greater than a reference speed, for example between 50 and 70 knots.

Of course, in the control of the aforementioned phases, conventional safety measures can be implemented to limit/prohibit the opening of the thrust reverser in flight, and/or before the aircraft has touched the ground during landing.

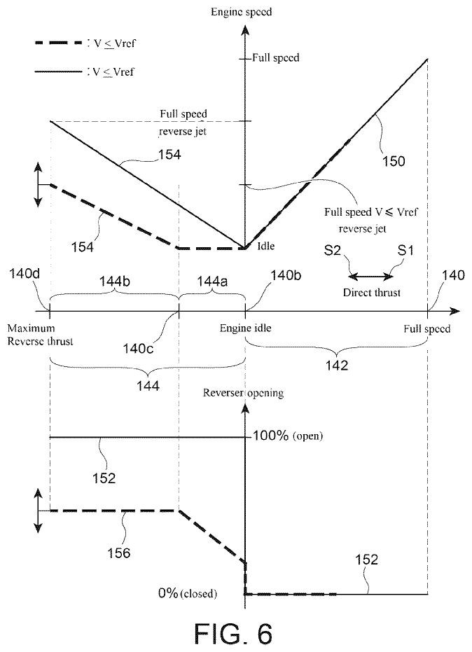

This conventional control of the propulsion unit 1 is schematized on the double graph of FIG. 6, by the dotted curve 150 at the top with regard to the engine speed, and by the dotted curve 152 at the bottom with regard to the opening of the reverser.

It is observed that the control principle described above only provides for a complete opening of the thrust reverser 30, or its complete closing. This principle thus contrasts with the command applied when the ground speed is less than or equal to the reference speed, as will be detailed below.

This is because, when at a step E3, the taxiing speed of the aircraft is detected to be less than or equal to the reference speed, the position of the lever 122 is determined at a step E4, which leads to a command specific to the present invention, involving partial openings of the reverser. In this respect, it is specified that the principle specific to the present invention applies not only to cases of taxiing of the aircraft when it is taxiing at a speed less than or equal to the reference speed, and/or to keep the aircraft stationary, when its speed is zero. For this reason, the speed reference can be set to up to zero.

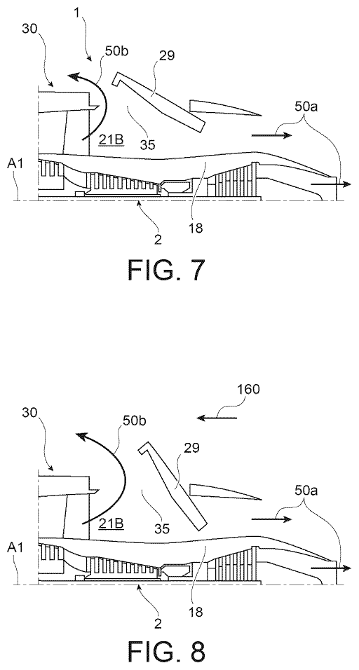

If the engine idle position 140b is detected, the system 120 implements an action A4 consisting in instructing the thrust reverser to occupy a minimum partial opening configuration shown in FIG. 7, so as to generate the reverse thrust flow 50b with a minimum intensity, preferably corresponding to the intensity of the direct thrust flow 50a escaping from the turbine engine from the primary duct and the secondary duct. The objective sought herein is to cause the double component of the direct thrust flow 50a and the component of the reverse thrust flow 50b to cancel each other, so that the propulsion unit 1 generates zero or substantially zero thrust. This action A4 also consists in instructing the turbojet 2 to apply idling speed, in order to obtain the desired result.

This action A4 then preferentially aims to keep the aircraft stationary despite the thrust generated at engine idle speed.

In the minimum partial opening configuration of FIG. 7, it is shown that the door 29 only releases a small portion of the opening 35, being slightly inclined, and only penetrating slightly into the secondary duct 21B.

If the detected position is in the direct thrust control zone 142, a step A5 is implemented, consisting in keeping the reverser in closed configuration, and adapting the engine speed according to the position of the throttle lever position.

If, on the other hand, the detected position is in the thrust reversal control zone 144, the nature of the control demanded by the system 120 will differ according to the precise position of the lever 122.

This is because, if the detected position is any first intermediate position within the first part 144a of the reversing control zone 144, the system 120 implements an action A6 consisting in instructing the thrust reverser to occupy a partial opening configuration, the opening level of which depends on the first intermediate position within the first part 142a of the zone 142. The further away this first intermediate position will be from the engine idle position 140b in the second direction S2, the higher the speed will be, and the greater the reverse thrust flow. Here, the objective is to generate the reverse thrust flow 50b with an intensity greater than that of the direct thrust flow 50a escaping the turbojet, so that the propulsion unit 1 generates a reverse thrust braking the taxiing of the aircraft. One of the particularities of this action A6 is that it is preferentially implemented by instructing the turbojet engine to maintain the idle speed. The intensity of the braking reverse thrust, which depends on the lever travel from the engine idle position 140b, thus depends only on the partial opening level of the reverser.

As with the action A4 and all other actions resulting in a partial opening of the reverser, it is noted that the engine control system 128 is configured to address a partial axial deployment instruction to the actuators 37 of the reverser. This is done very simply with electrical actuators, and for hydraulic actuators, for example, only the addition of valves controlled by feedback from a door position measurement is sufficient.

Consequently, the instruction given to the reverser is to occupy the partial opening configuration, i.e. to maintain this configuration until a new instruction is received. This contrasts with the simple passage of the reverser through this partially open configuration, in a transient manner, when this reverser moves from its closed configuration to its open configuration, or vice versa. In other words, the system controls the reverser so that it starts from the closed configuration, reaches and maintains the desired partial opening configuration, and returns to the closed configuration without reaching the open configuration, unlike in conventional reverser use.

If the detected position is the first reference intermediate position 140c shown in FIG. 4, the system 120 implements an action A7 consisting in instructing the reverser 30 to occupy a maximum taxiing opening configuration, preferably corresponding to a maximum partial opening configuration of the reverser. Here, too, a reverse thrust 160 delivered by the propulsion unit 1 is sought as a result of the flows 50a, 50b. Alternatively, in this control logic, it could be enabled to move the doors 29 of the reverser in their maximum deployment configuration, i.e. placing the reverser in the aforementioned open configuration. Nevertheless, as indicated above, when the taxiing speed is less than or equal to the reference speed, fully opening the reverser is avoided, the latter being able to adopt only a maximum partial opening configuration, shown in FIG. 8. This maximum partial opening configuration corresponds, for example, to 50% of the maximum opening capacity of the reverser, although this percentage may vary depending on the identified taxiing speed.

The action A7 also consists in instructing the turbojet 2 to maintain idle speed. However, due to the larger opening of the reverser, the reverse thrust flow 50b increases in favor of the two-component direct thrust flow 50a.

Finally, if the detected position is any second intermediate position within the second portion 144b of the reversing control zone 144, the system 120 implements an action A8 consisting in instructing the thrust reverser to maintain its maximum taxiing opening configuration. Furthermore, it instructs the turbojet engine to apply an engine speed which is a function of the second intermediate position within the second part 144b of the zone 144. The further away this second intermediate position will be from the reference intermediate position 140c in the second direction S2, the higher the speed will be, and the greater the reverse thrust flow. Here, the objective is to generate the reverse thrust flow 50b with an even greater intensity than that obtained with the implementation of actions A6 and A7, so that the propulsion unit 1 generates an even higher braking reverse thrust.

It is indicated that when the taxiing speed is less than or equal to the reference speed, the maximum engine speed enabled for the reverse thrust is preferably lower than that enabled in the phases where the speed is higher, in particular during the landing phase. For example, the maximum reverse thrust speed enabled corresponds to 50% of the maximum reverse thrust speed permitted at speeds above the reference speed, although this percentage may vary according to the identified taxiing speed.

This control specific to the invention is schematized on the double graph of FIG. 6, by the upper solid line curve 154 with respect to the engine speed, and by the lower solid line curve 156 with respect to the opening of the reverser.

In the control logic, it is provided that the braking force caused by the counterflow 50b can be added to the braking force caused on the wheels of the aircraft, via the dedicated pedals 124, shown in FIG. 2. But preferentially, it could be provided, that during the implementation of any of the aforementioned actions A4 to A8, the actuation of at least one of the pedals 124 is considered to be an additional braking request by the operator, in particular during an emergency situation, or an emergency braking request. Also, following the detection of such braking at a step E5, the system 120 implements, in addition to wheel braking, an action A9 consisting in instructing the thrust reverser to increase its opening if it is still possible, and/or to increase the engine speed if it is still possible. Therefore, in this situation, the reverser opening level and/or engine speed will no longer match those directly associated with the throttle lever position 122 within its module.

Triggering of the action A9 may nevertheless be dependent on the detection of a particular action on one for other or both of the two pedals 124, such as exceeding a certain pedal travel, and/or the detection of a high pedal movement speed, following the action of the foot of the operator.

Finally, it is noted that, regardless of the action performed among the actions A3, A4 and A6 to A9, the same flow redirection members are used within the reverser 30, namely the doors 29, which does not complicate the design of this reverser.

In the preferred embodiment just described, it is the same throttle lever 122 that is used for controlling all phases of the aircraft, whether in flight, landing, taxiing, etc. In particular, it therefore allows the specific control of the taxiing phase below the reference speed, but also the control of the engine speed in flight, as well as the control of the thrust reverser at landing.

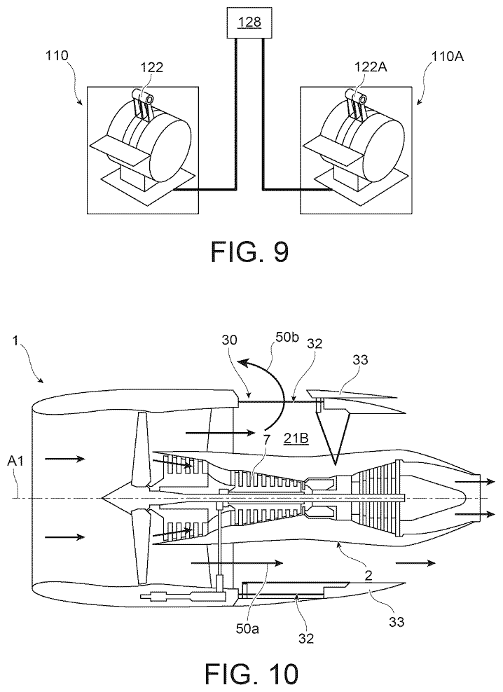

According to an alternative partially shown in FIG. 9, the control system further comprises a main throttle lever 122 within a main module 110A, also connected to the engine control system 128. The main throttle lever 122 is herein used for controlling the engine speed in flight, as well as for controlling the thrust reverser at landing, and more generally for all phases of the aircraft other than that of taxiing at a speed less than or equal to the reference speed.

The control system 120 is then configured such that the throttle lever 122 has authority over the main throttle lever 122A, as soon as the taxiing speed of the aircraft is less than or equal to the reference speed.

FIG. 10 for its part shows a propulsion unit 1 equipped with a reverser 30 according to another configuration, comprising herein thrust reversal grilles 32. The grilles 32 include, in a conventional manner, fins allowing the flow to be redirected forwards. Still in a known and conventional manner, the movement of the movable reverser covers 33 allows at least part of the secondary flow to be redirected forwards, to form the reverse-thrust flow 50b, thanks to the aforementioned fins. This type of grille reverser, movable or fixed, proves to be perfectly compatible with the principle of the invention set out above, as well as all existing types of reversers, capable of being partially open.

Furthermore, it is noted that, on the lever module 110, as many adjacent levers 122 as engines equipping the aircraft are usually provided, respectively dedicated to controlling the propulsion New Units 1 arranged on each of the two wings. These levers 122 can be moved simultaneously and identically by the operator, during the straight-line taxiing command. A differential movement of these two throttle levers 122 leads, in the reversing control zone 144, to providing different braking reverse thrust forces for the propulsion units 1. Advantageously, this makes it possible, for example, to make turns at a particularly low speed, using the braking principle specific to the invention, by implementing a partial opening of the thrust reversers.

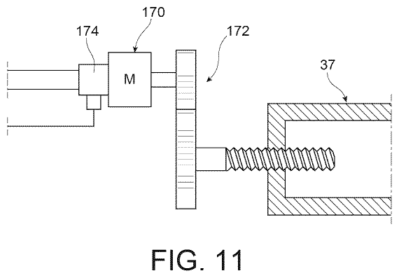

With reference to FIG. 11, one of the actuators 37, for example a ball screw, is shown, driven by an electric motor 170 via a mechanical transmission device 172. In a known manner, the regulation of the motor 170 is provided by control loops, such as a loop on the motor speed and a loop on the position of the hood or doors.

The motor 170 is equipped with a braking mechanism 174, at the output of the motor, allowing braking the deployment or closing in the event of loss of control of the motor, in order to avoid a high-energy impact at the end of travel of the movable cover 33 or the doors 29, which may lead to their separation from the thrust reverser. The invention further provides for making use of this braking mechanism 174, in order to maintain the reverser in its partial opening configuration.

To control the holding of the reverser in its partial opening configuration, using the braking mechanism 174, a computer first controls the position to be reached on the position feedback loop. Once the position is reached, the motor is slaved to zero speed, then the braking mechanism 174 is engaged, allowing the electrical supply to the motor 170 to be cut off. Thus the thrust reverser is maintained in the requested partial opening configuration, without electrical consumption, or excessive heating of the motor 170.

Various modifications may be made by a person skilled in the art to the invention just described, only by way of non-limiting examples, and the scope of which is defined by the appended claims. Moreover, it is noted that, on all the figures that have been described above, the elements bearing the same numerical references correspond to identical or similar elements.

Among the alternatives envisaged, the triggering of the partial opening of the reverser could be carried out by a control member other than the throttle lever, for example by one or other or both of the brake pedals.

1. System (120) for controlling an aircraft propulsion unit (1), the propulsion unit having a longitudinal central axis (A1) and comprising a turbine engine (2) configured to generate a direct thrust flow (50a), as well as a thrust reverser (30) configured to adopt:
a closed configuration in which the thrust reverser is inactive; and
an open configuration in which the thrust reverser is active, the open configuration allowing the reverser (30) to deflect at least a part of a flow passing through the turbine engine, in order to form a reverse thrust flow (50b) escaping from the propulsion unit with an axial direction opposite to that of the direct thrust flow (50a),
the control system comprising at least one control member (122, 124) operable by an operator,
wherein the control system is configured such that, when the taxiing speed of the aircraft is less than or equal to a reference speed, the control member (122, 124) can be moved into a position in which the control system instructs the thrust reverser (30) to occupy a partial opening configuration between the closed configuration and the open configuration, so as to generate an intense reverse-thrust flow (50b) lower than that generated in the open configuration, the control member being a throttle lever (122) capable of being placed in an engine idle position (140b), and moved in a first direction (S1) from this engine idle position, toward a full throttle position (140a), and moved in a second direction (S2) still from this engine idle position (140b), in a thrust reversal control zone (144), in the direction of a maximum reverse-thrust position (140d),
the control system being configured so that when the taxiing speed of the aircraft is less than or equal to the reference speed, the throttle lever (122) can be moved within the thrust reverse control zone (144) into at least one reverse thrust intermediate position in which the control system instructs the thrust reverser to occupy said partial opening configuration, the system being configured so that, when the taxiing speed of the aircraft is less than or equal to said reference speed and the throttle lever (122) occupies any first intermediate position within a first portion (144a) of the reversing control zone (144) located between the engine idle position (140b), and a reference intermediate position (140c), the control system commands the thrust reverser (30) to occupy a partial opening configuration, the opening level of which is a function of the first intermediate position within the first portion (144a) of the reversing control zone (144), so as to generate the reverse thrust flow (50b) with an intensity greater than that of the direct thrust flow (50a) escaping the turbine engine, so that the propulsion unit (1) generates a reverse thrust (160), preferably while maintaining the idle speed,
in the intermediate reference position of the throttle lever (122), the control system instructs the thrust reverser (30) to occupy a maximum taxiing opening configuration, corresponding to a maximum partial opening configuration of the reverser,
the system being configured so that, when the taxiing speed of the aircraft is less than or equal to said reference speed and the throttle lever (122) occupies any second intermediate position within a second portion (144b) of the reversing control zone (144) located between the intermediate reference position (140c) and the maximum reverse thrust position (140d), the control system Instructs the thrust reverser (30) to maintain its maximum taxiing opening configuration, and orders the application of an engine speed that is a function of the second intermediate position within the second portion (144b) of the reversing control zone (144), so as to generate the reverse thrust flow (50b) with an intensity greater than that of the direct thrust flow (50a) escaping the turbine engine, so that the propulsion unit generates a reverse thrust (160).

2. Control system according to claim 1, characterized in that it is configured so that when the taxiing speed of the aircraft is less than or equal to said reference speed and the throttle lever (122) is placed in the engine idle position (140b), the control system instructs the thrust reverser (30) to occupy a minimum partial opening configuration, so as to generate the reverse thrust flow (50b) with a minimum intensity, preferably corresponding to the intensity of the direct thrust flow (50a) escaping from the turbine engine (2), so that the propulsion unit (1) generates zero or substantially zero thrust.

3. Control system according to claim 1, characterized in that said throttle lever (122) is provided in addition to a main throttle lever (122A) used for controlling the engine speed in flight, as well as for controlling the thrust reverser at landing, the control system being then configured so that the throttle lever (122) has authority over the main throttle lever (122A) provided that the taxiing speed of the aircraft is less than or equal to the reference speed.

4. Control system according to claim 1, characterized in that said throttle lever (122) is also used for controlling the engine speed in flight, as well as for controlling the thrust reverser (30) at landing.

5. Control system according to claim 1, comprising at least one brake pedal (24), the system being configured so that actuation of said at least one brake pedal (124) is considered to be an additional braking request by the operator, and so that, following detection of such braking, the system implements, in addition to wheel braking, an action of instructing the thrust reverser to increase its opening if it is still possible, and/or to increase the engine speed if it is still possible.

6. Control system according to claim 1, wherein the reverser comprises at least one actuator (37) driven by an electric motor (170) equipped with a braking mechanism (174) configured to hold the reverser in its partially open configuration.

7. Control system according to claim 1, characterized in that it furthermore comprises:
a motor regulation system (128) connected to the control member (122, 124) so that the position thereof is transmitted to the regulation system (128), the latter being configured to provide opening/closing instructions to the thrust reverser (30), as well as to provide engine speed instructions to the turbine engine (2);
a processing unit (130) connected to the engine control system (128), the processing unit (130) being configured to receive information relating to the taxiing speed of the aircraft, and to transmit this information to the engine control system (128).

8. Method for controlling an aircraft propulsion unit (1) using a control system (120) according to claim 1, characterized in that, when the taxiing speed of the aircraft is less than or equal to said reference speed, the thrust reverser (30) is instructed, in response to placing the control member (122, 124) in a given position, to occupy a partially open configuration between the closed configuration and the open configuration, so as to generate a reverse thrust (50b) of lower intensity than that generated in the open configuration.

9. Aircraft (100) comprising at least one propulsion unit (1) as well as a control system (120) of this unit, according to claim 1, the propulsion unit (1) comprising a turbine engine (2) configured to generate a direct thrust flow (50a), as well as a thrust reverser (30) configured to adopt:
a closed configuration in which the thrust reverser is inactive; and
an open configuration in which the thrust reverser is active, the open configuration allowing the reverser (30) to deflect at least a part of a flow passing through the turbine engine, in order to form a reverse thrust flow (50b) escaping from the propulsion unit (1) with an axial direction opposite to that of the direct thrust flow (50a).

10. Aircraft according to claim 9, characterized in that the thrust reverser (30) of the propulsion unit includes flow redirection members (29, 32) for generating the reverse thrust flow (50b), the control member being a throttle lever (122), and in that the reverser (30) is designed so that these same flow redirection members (29, 32) are used at the same time when the lever (122) is placed in a position in which the control system (120) instructs the thrust reverser (30) to occupy a partially open configuration between the closed configuration and the open configuration, and when this lever (122) is placed in a maximum reverse thrust position (140d).
